(19) United States
(12) Patent Application Publication
(10) Pub. No.: US 2005/0031351 A1
(43) Pub. Date: Feb. 10, 2005

(54) Communication system by terminal with no power supply

(75) Inventors: Takuichi Nishimura, Tokyo (JP); Hideo Itoh, Tsuchiura-shi (JP); Yoshinobu Yamamoto, Tokyo (JP); Hideyuki Nakashima, Tsuchiura-shi (JP); Itsuki Noda, Tsukuba-shi (JP)

Correspondence Address: VENABLE, BAETJER, HOWARD AND CIVILETTI, LLP, P.O. BOX 34385, WASHINGTON, DC, 20043-9998, US

(73) Assignee: National Institute of Advanced Industrial Science and Technology, Tokyo (JP)

(21) Appl. No.: 10/496,872

(22) PCT Filed: Nov. 26, 2002
(86) PCT No.: PCT/JP02/12306

(30) Foreign Application Priority Data
Nov. 26, 2001 (JP) 2001-358657
Dec. 5, 2001 (JP) 2001-371692
Dec. 11, 2001 (JP) 2001-376867
Dec. 18, 2001 (JP) 2001-383972

(51) Int. Cl. H04B 10/00

(52) U.S. Cl. 398/135; 398/118

(57) ABSTRACT

A communication system includes a power-sourceless terminal (10) and a transmitting station (20). The power-sourceless terminal includes a photoelectric conversion section for receiving an intensity modulated optical signal and converting it to an electric signal, and a voice output section for outputting the electric signal passing through the conversion by the photoelectric conversion section in the form of voice. The transmitting station includes a transmission section for transmitting the optical signal having its intensity modulated depending on an electric signal of the information to be transmitted.

### TECHINICAL FIELD

The present invention relates to a communication system with a power-sourceless terminal, particularly to a novel communication system with a power-sourceless terminal which is capable of carrying out optical space communication of readily downloading information from an environment side to a large number of terminal users and also optical space communication of readily uploading information from each terminal user to the environment side.

### BACKGROUND ART

In the Japanese Patent Application Laid-open Nos. 8-107386 (1996) and 2000-022637, there are disclosed optical communication techniques for conducting a communication with light.

The Japanese Patent Application Laid-open No. 8-107386 (1996) discloses a communication system wherein only a main optical transmitter unit has a power source and this main optical transmitter unit transmits electric power optically to a subordinate transmitter unit. According to this communication system, there is no need for a power source of the subordinate transmitter unit since the electric power is optically transmitted from the main optical transmitter unit. And for example, a telephone system with a telephone with no power source can be realized by optically transmitting an electric power light and an information signal light simultaneously from a telephone station (main optical transmitter unit) to a telephone (subordinate transmitter unit) via an optical fiber.

The Japanese Patent Application Laid-open No. 2000-022637 discloses a communication system wherein a receiver outputs a laser beam toward a transmitter and the transmitter sends back the laser beam after modulating its intensity in order to transmit information to the receiver. According to this communication system, for example, one-to-many communication can be realized by appropriately placing one transmitter and many receivers in an event place and so on.

However, in the case where the light is used as a power source like the former communication system, repetition of on and off of the light for information transmission will affect voltage of the electric signal obtained by photoelectric conversion. Thus, in order to supply the power steadily, a constant voltage circuit will be needed and also an intensity of the light used for the communication must be very strong. Accordingly, when performing the communication and the power energy supply simultaneously by using light, the communication system, particularly the receiver circuit, becomes large and complicated.

Further, in the case where the communication is performed by modulating the light like the latter communication system, an optical modulation means such as a liquid crystal will be needed for the information transmitter, and such optical modulation means usually requires a power source and thus cannot be equipped in the transmitter having no power source.

### DISCLOSURE OF THE INVENTION

Accordingly, it is an object of the present invention to provide a novel communication system capable of readily carrying out optical space communication between an environment side which has a station for transmitting and receiving information and user terminals which need no exclusive power source such as a dry battery and have simple circuit configuration, thereby being small in size, light in weight and easily carryable and wearable.

Another object of the present invention is to provide a novel terminal with no power source capable of carrying out optical space communication of readily downloading information from an environment side to a terminal user and also optical space communication of readily uploading information from the terminal user to the environment side, thereby being a user terminal capable of readily utilizing the communication system.

In order to accomplish the above objects, according to a first aspect of the present invention, there is provided a communication system with a power-sourceless terminal comprising:
a power-sourceless terminal including photoelectric conversion means for receiving an intensity modulated optical signal and converting it to an electric signal, and voice output means for outputting the electric signal converted by the photoelectric conversion means in the form of voice; and
a transmitting station including transmission means for sending an optical signal having its intensity modulated depending on an electric signal of information to be transmitted to the power-sourceless terminal.

According to a second aspect of the present invention, there is provided a communication system with a power-sourceless terminal comprising:
a power-sourceless terminal including photoelectric conversion means for receiving an intensity modulated optical signal and converting it to an electric signal, demodulation means for demodulating the electric signal converted by the photoelectric conversion means, and voice output means for outputting the electric signal demodulated by the demodulation means in the form of voice; and
a transmitting station including modulation means for carrying out analog modulation or digital modulation of an electric signal of information to be transmitted, and transmission means for sending an optical signal having its intensity modulated depending on the electric signal modulated by the modulation means to the power-sourceless terminal.

According to a third aspect of the present invention, there is provided a communication system with a power-sourceless terminal comprising:
a power-sourceless terminal including photoelectric conversion means for receiving a portion of an intensity modulated optical signal and converting it to an electric signal, voice output means for outputting the electric signal converted by the photoelectric conversion means in the form of voice, and reflecting means for receiving and reflecting another portion of the intensity modulated optical signal, the power-sourceless terminal enabling a terminal user to modify the intensity of the optical signal in accordance with information to be sent by the terminal user upon reflection by the reflecting means;
a transmitting station including transmission means for sending the optical signal having its intensity modulated depending on an electric signal of information to be transmitted to the power-sourceless terminal; and
a receiving station including light receiving means for receiving the optical signal reflected by the reflecting means of the power-sourceless terminal, and information analyzing means for analyzing the information the terminal user sends from the power-sourceless terminal in accordance with the intensity of the optical signal received by the light receiving means.

According to a fourth aspect of the present invention, there is provided a communication system with a power-sourceless terminal comprising:
a power-sourceless terminal including photoelectric conversion means for receiving an intensity modulated optical signal and converting it to an electric signal, voice output means for outputting the electric signal converted by the photoelectric conversion means in the form of voice, and reflecting means for receiving and reflecting upload light, the power-sourceless terminal enabling a terminal user to modify the intensity of the upload light in accordance with information to be sent by the terminal user upon reflection by the reflecting means;
a transmitting station including transmission means for sending the optical signal having its intensity modulated depending on an electric signal of information to be transmitted to the power-sourceless terminal; and
a receiving station including light-emitting means for emitting the upload light, light receiving means for receiving the upload light reflected back by the reflecting means of the power-sourceless terminal, and information analyzing means for analyzing the information the terminal user sends from the power-sourceless terminal in accordance with the intensity of the upload light received by the light receiving means.

According to a fifth aspect of the present invention, there is provided a communication system with a power-sourceless terminal comprising:
a power-sourceless terminal including photoelectric conversion means for receiving a portion of an intensity modulated optical signal and converting it to an electric signal, demodulation means for demodulating the electric signal converted by the photoelectric conversion means, voice output means for outputting the electric signal demodulated by the demodulation means in the form of voice, and reflecting means for receiving and reflecting another portion of the intensity modulated optical signal, the power-sourceless terminal enabling a terminal user to modify the intensity of the optical signal in accordance with information to be sent by the terminal user upon reflection by the reflecting means;
a transmitting station including modulation means for carrying out analog modulation or digital modulation of an electric signal of information to be transmitted, and transmission means for sending an optical signal having its intensity modulated depending on the electric signal modulated by the modulation means to the power-sourceless terminal; and
a receiving station including light receiving means for receiving the optical signal reflected by the reflecting means of the power-sourceless terminal, and information analyzing means for analyzing the information the terminal user sends from the power-sourceless terminal in accordance with the intensity of the optical signal received by the light receiving means.

According to a sixth aspect of the present invention, there is provided a communication system with a power-sourceless terminal comprising:
a power-sourceless terminal including photoelectric conversion means for receiving an intensity modulated optical signal and converting it to an electric signal, demodulation means for demodulating the electric signal converted by the photoelectric conversion means, voice output means for outputting the electric signal demodulated by the demodulation means in the form of voice, and reflecting means for receiving and reflecting upload light, the power-sourceless terminal enabling a terminal user to modify the intensity of the upload light reflected by the reflecting means in accordance with information to be sent by the terminal user;
a transmitting station including modulation means for carrying out analog modulation or digital modulation of an electric signal of information to be transmitted, and transmission means for sending an optical signal having its intensity modulated depending on the electric signal modulated by the modulation means to the power-sourceless terminal; and
a receiving station including light-emitting means for emitting the upload light, light receiving means for receiving the upload light reflected back by the reflecting means of the power-sourceless terminal, and information analyzing means for analyzing the information the terminal user sends from the power-sourceless terminal in accordance with the intensity of the upload light received by the light receiving means.

In these aspects, the communication system of the present invention may have other characteristics wherein the photoelectric conversion means of the power-sourceless terminal includes a solar cell, the voice output means of the power-sourceless terminal includes an earphone, a headphone or a speaker or the reflecting means of the power-sourceless terminal includes a retroreflector.

On the other hand, as to the power-sourceless terminal used in the communication system of the present invention, it may be further characterized in that a solar cell used as the photoelectric conversion means, and at least one of an earphone, a headphone and a speaker used as the voice output means are arranged so as to form integurated structure,
the solar cell and at least one of the earphone, the headphone and the speaker are arranged so as to form integurated structure such that when the terminal user wears at least one of the earphone, the headphone and the speaker, a light receiving surface of the solar cell faces in a direction of the terminal user's eyes,
a solar cell used as the photoelectric conversion means, at least one of an earphone, a headphone and a speaker used as the voice output means and a retroreflector used as the reflecting means are arranged so as to form integurated structure or
the solar cell, at least one of the earphone, the headphone and the speaker, and the retroreflector are arranged so as to form integurated structure such that when the terminal user wears at least one of the earphone, the headphone and the speaker, a light receiving surface of the solar cell and a light reflecting surface of the retroreflector face in a direction of the terminal user's eyes.

In addition, the power-sourceless terminal may be further characterized in that the power-sourceless terminal further comprises
optical intensity modulation means for varying intensity of the optical signal passing through a airtight container thereof due to variations of optical transmittance of the airtight container in accordance with pressure fluctuations, the airtight container having a light transmittable elastic component capable of letting the optical signal to enter into and exit from the airtight container and a plurality of particles sealed therein; and
wherein the power-sourceless terminal is capable of varying intensity of the optical signal in accordance with the information by the optical intensity modulation means,
optical intensity modulation means for varying intensity of the upload light passing through an airtight container thereof due to variations of optical transmittance of the airtight container in accordance with pressure fluctuations, the airtight container having elastic component capable of letting the upload light to enter into and exit from the airtight container and a plurality of particles sealed therein; and
   wherein the power-sourceless terminal is capable of varying intensity of the upload light in accordance with the information by the optical intensity modulation means,
the optical intensity modulation means further comprises a component operable to provide the airtight container with the pressure fluctuation by conducting voice to the airtight container, the voice expressing the information to be sent by the terminal user or
the optical intensity modulation means further comprises a component operable to provide the airtight container with the pressure fluctuations in accordance with mechanical operations by the terminal user, the mechanical operation expressing the information to be sent by the terminal user.

Finally, the foregoing communication system and power-sourcelss terminal may be further characterized in that the power-sourceless terminal further comprises storage means for storing electric energy of the electric signal converted by the photoelectric conversion means.

According to the communication system and power-sourcelss terminal with the foregoing characteristics, as for the user terminal required for the optical space communication with the environment side having the transmitting station and receiving station disposed, it includes the photoelectric conversion means such as a solar cell, and the sound output means such as an earphone, as well as the reflecting means such as the retroreflector as needed, and is capable of the power-sourceless drive, thereby being able to implement the simple, compact, lightweight power-sourceless terminal. Employing the power-sourceless terminal enables the environment side to take a very simple configuration, to readily download the information to the terminal user, and to easily upload the information from the terminal user, thereby being able to implement the very convenient optical space communication system.

For example, voice information on an exhibition hall or exhibits is transmitted so that participants can receive and hear the information through the power-sourceless terminals. Thus, a variety of one-to-many communication spaces can be implemented as to events or exhibitions using the power-sourceless terminals for providing various types of information.

In addition, the configuration, in which the terminal user can vary the intensity of the light received by the power-sourceless terminal with his or her hand or by operating the power-sourceless optical intensity modulation means installed in the terminal, enables the terminal user to upload information to the environment side using only the terminal the user carries, and thus enables the individual participants to send their own intentions in the events or exhibitions, thereby being able to implement the many-to-one communication space together with the one-to-many communication. As for the optical intensity modulation means, since it carries out the intensity modulation of light in response to the pressure variations utilizing the vibrations of air or the like, it enables the power-sourceless drive.

Furthermore, the communication system can reduce the effect of noise on the light used for the communication by passing the electric signal of the information, which is to be downloaded from the environment side to the terminal side, through the analog modulation such as AM or FM modulation, or the digital modulation such as PAM, PWM or PPM, thereby being able to implement the superior communication space.

In this case, although the power-sourceless terminal must include a demodulation means such as a demodulation circuit, its power-sourceless drive is also possible depending on the circuit configuration and devices used. Alternatively, even if the power supply is required, it becomes possible without using any other signal lines for the power supply or constant voltage circuit by storing the electric energy of the electric signal obtained by converting the received light by the photoelectric conversion means in the storage means such as a secondary battery. The power-sourceless terminal is sufficiently compact and lightweight even when the demodulation circuit or secondary battery is installed, thereby being able to keep the portability and fittability.

### BRIEF DESCRIPTION OF THE DRAWINGS

FIGS. 1A and 1B are each a schematic diagram illustrating an embodiment in accordance with the present invention;

FIG. 2 is a block diagram showing a circuit configuration of a power-sourceless terminal;

FIG. 3 is a block diagram showing a circuit configuration of a transmitting station;

FIG. 4 is a block diagram showing a circuit configuration of a receiving station;

FIG. 5 is a perspective view showing an external appearance of another embodiment of the power-sourceless terminal;

FIG. 6 is a perspective view showing an external appearance of still another embodiment of the power-sourceless terminal;

FIG. 7 is a schematic diagram illustrating an example of an application of the present invention;

FIG. 8 is a schematic diagram illustrating another example of an application of the present invention;

FIGS. 9A and 9B are each a waveform chart illustrating a waveform of an electric signal passing through photoelectric conversion by a receiving station when uploading information from a power-sourceless terminal, and FIG. 9C is a waveform chart illustrating intensity variations of the light emitted from a transmitting station;

FIG. 10 is a schematic diagram illustrating another embodiment in accordance with the present invention;

FIG. 11 is a cross-sectional view showing a structure of an optical intensity modulation means in the embodiment as shown in FIG. 10;

FIG. 12 is a perspective view showing an external appearance of the optical intensity modulation means in the embodiment as shown in FIG. 10;

FIG. 13 is a cross-sectional view showing a structure of a mechanical vibration generating means attached to the optical intensity modulation means in the embodiment of FIG. 10;

FIG. 14 is a block diagram illustrating another embodiment in accordance with the present invention;

FIG. 15 is a schematic diagram illustrating still another embodiment in accordance with the present invention;

FIG. 16 is a waveform chart illustrating distribution of optical intensity; and

FIG. 17 is a block diagram showing still another embodiment in accordance with the present invention.

### BEST MODE FOR CARRYING OUT THE INVENTION

(First Embodiment)

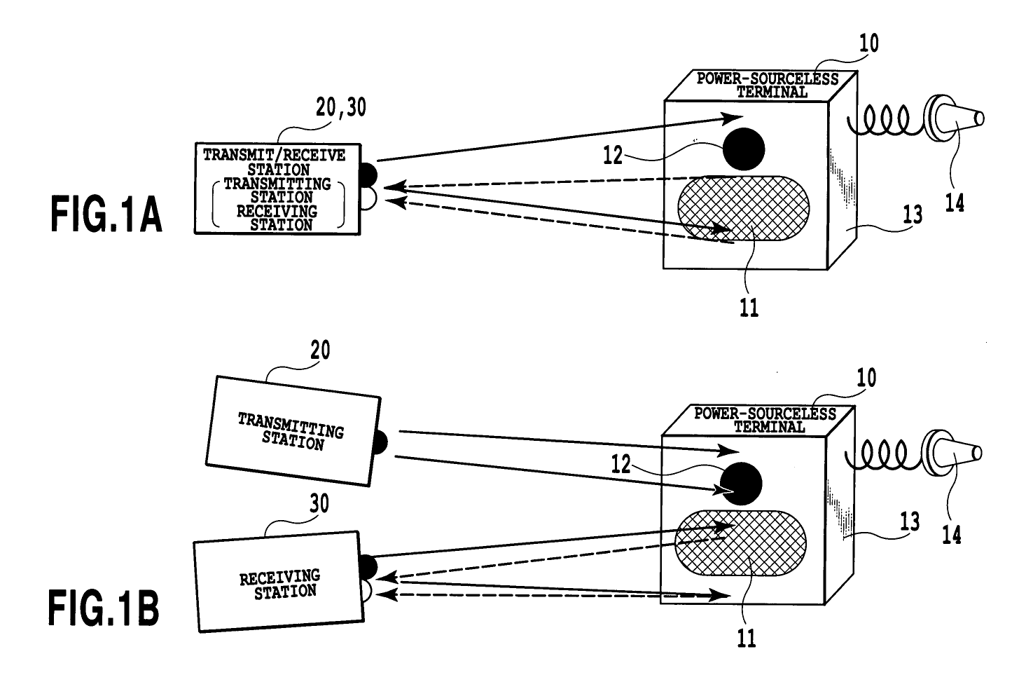

FIGS. 1A and 1B each show a first embodiment in accordance with the present invention. As shown in FIGS. 1A and 1B, the communication system in accordance with the present invention has a basic configuration including a power-sourceless terminal 10 to be worn by a user, and a transmitting station 20 and a receiving station 30 installed in an environment side. The transmitting station 20 and receiving station 30 can be integrated (FIG. 1A) or separated (FIG. 1B).

First, the example of FIG. 1A will be described. In download communication, the transmitting station 20 sends the power-sourceless terminal 10 an optical signal having its intensity modulation in response to an electric signal of the information to be transmitted, thereby carrying out the download transmission. On the other hand, the power-sourceless terminal 10 receives a part of the intensity modulated optical signal transmitted by the transmitting station 20, converts it to an electric signal, and outputs the electric signal in the form of voice (voice sometimes is called speech), thereby carrying out the download reception.

In upload communication, the power-sourceless terminal 10 receives and reflects another part of intensity modulated optical signal transmitted by the transmitting station 20, and modifies the intensity of the optical signal at the reflection in accordance with the information originated by the terminal user, thereby carrying out the upload transmission. On the other hand, the receiving station receives the optical signal reflected back from the power-sourceless terminal 10, and analyzes the information the terminal user transmits from the power-sourceless terminal 10 in accordance with the intensity of the optical signal, thereby carrying out the upload reception.

Next, the example of FIG. 1B will be described. In download communication, the transmitting station 20 sends the power-sourceless terminal 10 an optical signal having its intensity modulation in response to an electric signal of the information to be transmitted, thereby carrying out the download transmission. On the other hand, the power-sourceless terminal 10 receives the intensity modulated optical signal transmitted by the transmitting station 20, converts it to an electric signal, and outputs the electric signal in the form of voice, thereby carrying out the download reception.

In upload communication, the power-sourceless terminal 10 receives and reflects the upload light sent out from the receiving station 30, and modifies the intensity of the upload light at the reflection in accordance with the information originated by the terminal user, thereby carrying out the upload transmission. On the other hand, the receiving station sends the upload light to the power-sourceless terminal 10, receives the upload light reflected back from the power-sourceless terminal 10, and analyzes the information the terminal user transmits from the power-sourceless terminal 10 in accordance with the intensity of the upload light, thereby carrying out the upload reception.

Therefore the difference between FIG. 1A and FIG. 1B is that the light for the download and upload is shared in FIG. 1A, but separated in FIG. 1B.

The power-sourceless terminal 10 of the examples in FIGS. 1A and 1B will be described more specifically. It has a casing 13, on which are mounted an optical sensor 12 such as a solar cell for the photoelectric conversion of the optical signal from the transmitting station 20, and a retroreflector 11 in the form of a reflecting plate or reflecting sheet for reflecting the optical signal or the upload light back to the receiving station 30. In addition, an earphone 14 for outputting the electric signal fed from the optical sensor 12 as the voice output is detachably connected to the casing 13 via a connector.

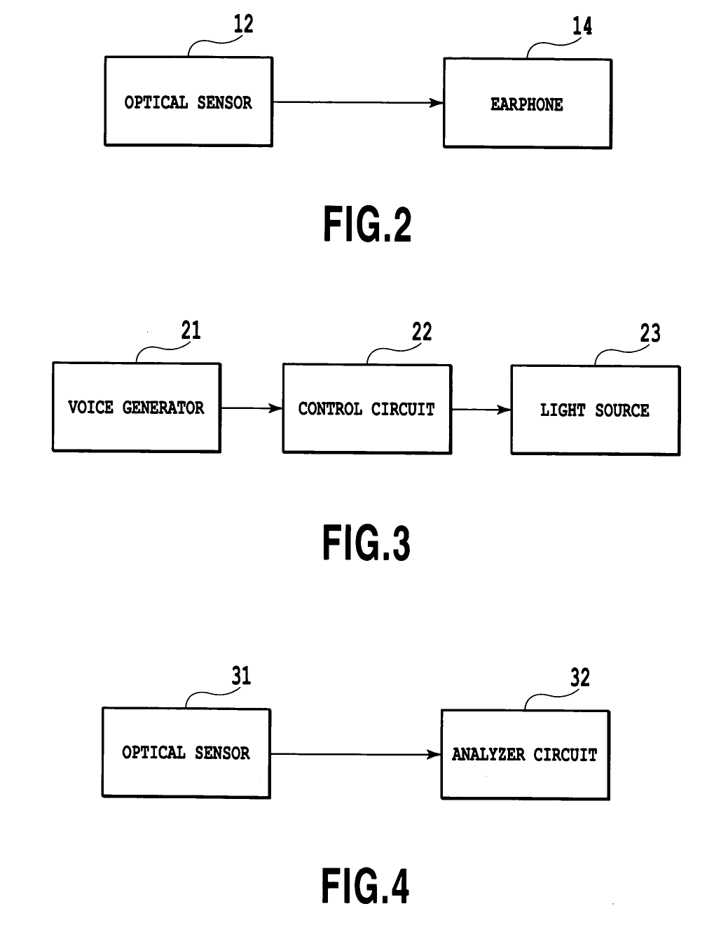

In FIG. 1A, the transmitting station 20 and receiving station 30 have a single-piece construction with its light source 23 (FIG. 2) and optical sensor 31 (FIG. 3) being installed at nearly the same location. This is because since the optical signal transmitted from the transmitting station 20 is reflected precisely in the same direction as the direction of incidence by the retroreflector 11 of the power-sourceless terminal 10, the light-emitting position and receiving position must be set at nearly the same location. Thus, the single-piece construction in which the download and upload share the light can be implemented. In contrast with this, in the configuration of FIG. 1B, they are located separately to transmit and receive the light separately to and from the power-sourceless terminal 10.

The power-sourceless terminal 10 has a circuit configuration as shown in FIG. 2, for example. It includes the optical sensor 12 and the earphone 14 directly connected thereto via a lead. In the circuit thus configured, the optical sensor 12 receives the intensity modulated optical signal transmitted from the transmitting station 20, and drives the earphone 14 with the electric signal produced by the photoelectric conversion, thereby reproducing the electric signal as the output. In this case, the earphone 14 is driven by an AC component conveying the information signal without using the DC component the optical sensor 12 produces at the same time. In other words, the voice output is achieved by the power-sourceless mode using only the AC component.

On the other hand, the retroreflector 11 is used only for the upload. Thus, it is not connected to the optical sensor 12 and earphone 14 for the download. In other words, it demands no electricity. When the optical signal (FIG. 1A) or the upload light (FIG. 1B) is reflected back to the receiving station 30 by the retroreflector 11, the terminal user can modify the optical intensity by placing his or her hand before the retroreflector 11 to interrupt the optical path entirely or by half. Carrying out the manual operation in response to the user's own intentional information (such as selection of YES or NO) can vary the optical intensity to be sent back in response to it, thereby enabling the upload transmission of the intentional information without using any power source.

Incidentally, as for the example of FIG. 1A, the phrases “receives a part of the optical signal and carries out photoelectric conversion thereof” and “receives another part of the optical signal and reflects it” mean the following. First, the former phrase means of receiving the optical signal to such an extent that the optical sensor 12 can receive the optical signal with its receiving surface. Second, the latter phrase means of receiving the optical signal to such an extent that the retroreflector 11 can receive the optical signal with its receiving surface independently of the optical sensor 12.

The transmitting station 20 has a circuit configuration as shown in FIG. 3. It includes a voice generator 21, a control circuit 22 and a light source 23. The voice generator 21 is a generator of the information to be transmitted to the power-sourceless terminal 10, and a well-known apparatus such as a microphone, tape recorder and information processing unit is available. The control circuit 22 is a circuit for modulating the intensity of the optical signal generated by the light source 23 by controlling the light source 23. For example, the intensity modulation control of the optical signal can be carried out by varying the drive voltage of the light source 23 in response to the voltage level of the voice signal generated by the voice generator 21. The light source 23 generates the light under the control of the control circuit 22, and can control its optical intensity in response to the frequency of the information to be transmitted. As the light source, a device such as an infrared light-emitting diode capable of emitting plenty of light is available. As for light-emitting diodes, they can be arrayed to increase the light intensity in accordance with the transmission distance required. In addition, it is preferable to provide the light source 23 with the directivity so that its emitting light is sent out in a specified direction. To achieve this, a configuration is to be considered in which a light-emitting source consisting of an LED array is placed at the focal point of a reflector with a parabolic reflection surface.

Although the transmitting station 20 outputs voice using the light in the present embodiment, this is not essential. For example, according to the application purpose, the voice generator 20 can be replaced by an information generator suitable for the output mode such as an audio and so forth.

The receiving station 30 has a circuit configuration including an optical sensor 31 and an analyzer circuit 32 as shown in FIG. 4, for example. The example of FIG. 1B further includes a light source for emitting the upload light. The optical sensor 31 receives the optical signal to be sent by the transmitting station 20 and reflected by the power-sourceless terminal 10 (in the case of FIG. 1A), or receives the upload light to be sent by the receiving station 30 itself and reflected by the power-sourceless terminal 10 (in the case of FIG. 1B), and then carries out the photoelectric conversion of the optical signal to output an electric signal. As the optical sensor 31, a photodiode or an image pickup device for a camera is applicable. A second dimensional photodiode array can also be used. The analyzer circuit 32 analyzes the information transmitted by the user of the power-sourceless terminal 10 in response to the electric signal output from the optical sensor 31. For example, consider the case where the user sends, that is, uploads to the environment side the instructions as to the selection of the information transmitted to the power-sourceless terminal 10 by the manual ON/OFF operation to indicate YES or NO. As described before, the optical signal or upload light which bears the intensity the user assigns thereto by the manual operation is reflected back. Thus the analyzer circuit 32 analyzes the optical intensity to restore the selection instruction information about YES/NO sent from the user of the power-sourceless terminal 10. In the analysis, the analyzer circuit 32 can determine YES or NO by comparing the voltage level of the electric signal output from the optical sensor 31 with a predetermined threshold value. The analytical results are output in binary notation of ON/OFF, or can be output in the form of a signal representing the contents of the information the terminal user wishes to transmit in accordance with the application purpose. In the foregoing case, they can be output in the form of a character code signal or voice signal representing YES/NO, for example.

Therefore the interactive communication between the environment side and user side can be implemented by constructing the system such that according to the analytical result signal, the transmitting station 20 can transmit the download information corresponding the upload information (YES/NO in the foregoing case) transmitted to the environment side by the terminal user.

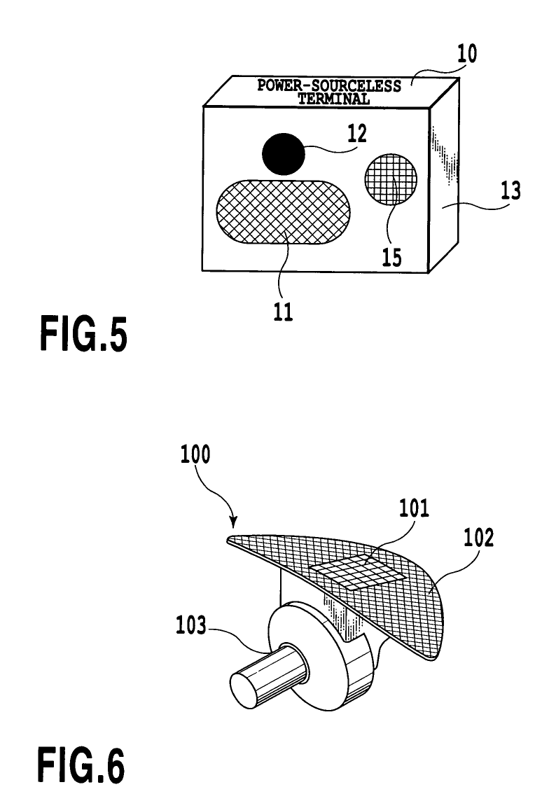

As for the power-sourceless terminal 10 used in the communication system in accordance with the present invention, it can have a speaker 15 incorporated into the casing 13 as shown in FIG. 5 instead of the earphone 14 as shown in FIG. 1. In this case, the card-type power-sourceless terminal 10 with reduced thickness and weight can be implemented by thinning not only the casing 13, but also the optical sensor 12, retroreflector 11 and speaker 15 incorporated into the casing. To achieve the card type, it is preferable to employ a solar cell and recursive reflecting sheet as the optical sensor 12 and retroreflector 11. It is obvious that terminal can include both the earphone 14 and speaker 15.

Alternatively, an earphone-type power-sourceless terminal as shown in FIG. 6 is also possible. The power-sourceless terminal 100 shown in FIG. 6 includes an earphone 103, a solar cell 101, and a recursive reflecting sheet 102 integrated into a single unit. More specifically, a sheet-like optical transceiver having the recursive reflecting sheet 102 placed around the solar cell 101 on nearly the same surface is attached to an ear attachment including the earphone 103. The light receiving surface of the solar cell 101 and the light reflection surface of the recursive reflecting sheet 102 are disposed such that they are integrated into a single-piece construction, and face in the direction of vision of the terminal user when the terminal user wears the earphone 103. The terminal includes only the lead (not shown) connecting between the output terminal of the solar cell (11a) and the input terminal of the earphone (12a) without a power supply such as a battery for driving the earphone (12a). This is because since the electric signal produced by the solar cell (11a) directly drives the earphone (12a) to output the voice as described before, no other dedicated power supply is required. The earphone-type power-sourceless terminal 100 can implement superior terminal fittability, enabling the terminal user to exploit the interactive communication with the environment side.

It is obvious that various types of the power-sourceless terminals such as the earphone-type and card-type can be appropriately used in accordance with the environment or application purpose.

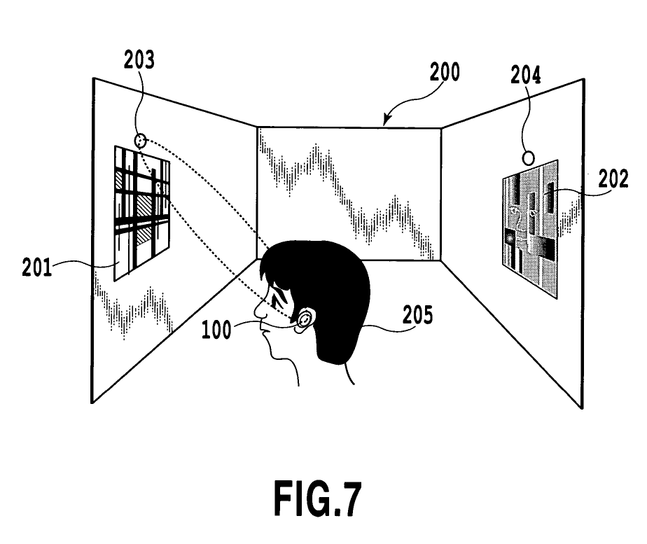

The operation of the communication system with the foregoing configuration will be described when used as an information system of exhibits of a museum as shown in FIG. 7. In FIG. 7, an exhibition hall 200 of the museum has exhibits 201 and 202 such as pictures hung on its walls. Above the exhibits 201 and 202, transmit/receive stations 203 and 204 are placed for providing information about the exhibits 201 and 202, respectively. The transmit/receive stations 203 and 204 have their voice generators 21 (FIG. 3) store voice information about the exhibits 201 and 202 in advance, and have their control circuits 22 (FIG. 3) control the light sources 23 (FIG. 3) such that they emit the optical signals, that is, the intensity modulated optical signals, in specified directions in response to the levels of the voice signals of the voice information. A visitor or a terminal user 205 wears the earphone-type power-sourceless terminal 100 on his or her ear. Accordingly, when the user looks at the exhibit 201, or turns in the direction of the emitted optical signal in front of the exhibit 201, the light receiving surface of the solar cell 101 of the power-sourceless terminal 100 faces toward the transmit/receive stations 203. Thus, the power-sourceless terminal 100 receives with the solar cell 101 the optical signal emitted from the transmit/receive station 203. As a result, when the solar cell 101 carries out the photoelectric conversion of the optical signal received, the voice information on the exhibit 201 is reproduced and output from the earphone 103. When the voice information inquires, “Do you want another piece of information?” at its final section, the user can reply as follows. To make a positive answer “YES”, the terminal user 205 has the recursive reflecting sheet 102 of the power-sourceless terminal 100 reflect the light emitted from the transmitting station 20 toward the optical sensor 31 of the receiving station 30 for a specified time period (FIG. 4). To make a negative answer “NO”, the user has the optical signal reflected toward the optical sensor 31 of the receiving station 30, immediately followed by interrupting the light with hand, or preventing the transmission of the light to the optical sensor 31 by changing the reflection angle. Incidentally, the terminal user can upload some pieces of intentional information other than “YES” and “NO” by interrupting the light twice, three or four times with hand at short time intervals.

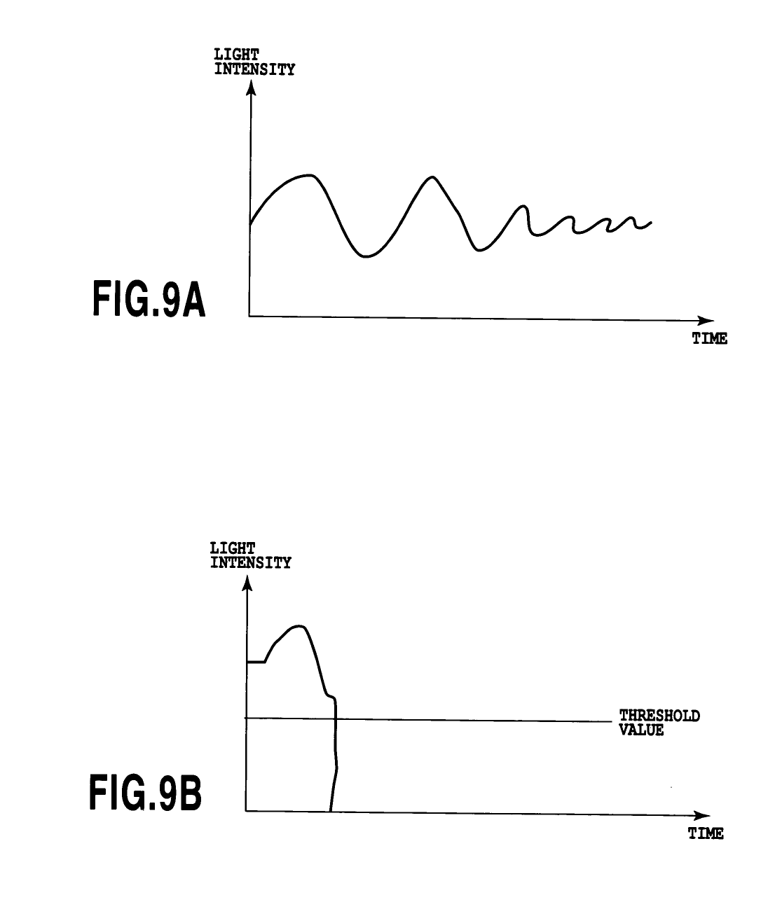

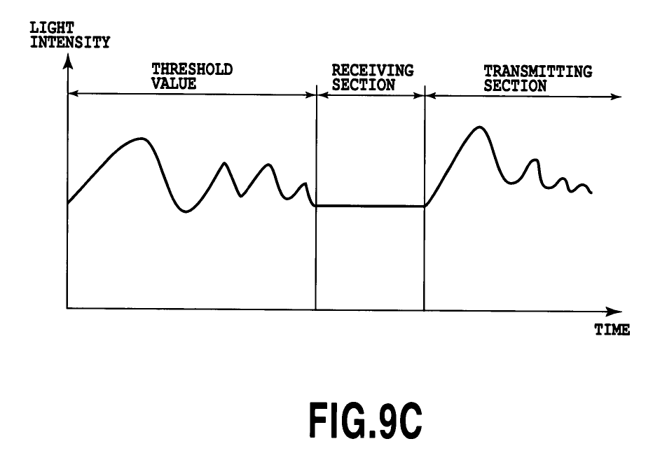

In the receiving station 30, the analyzer circuit 32 (FIG. 4) compares the voltage level of the electric signal output from the optical sensor 31 as illustrated in FIG. 9A with a predetermined threshold value as illustrated in FIG. 9B to make an analysis and decision as to the reply of the visitor as follows, for example.

(1) After an electric signal greater than the threshold value occurs, the analyzer circuit 32 measures the time period in which the level of the electric signal falls below the threshold value. If the measured time period is greater than the specified time period, the analyzer circuit 32 makes a decision that the reply of the visitor is “YES”.

(2) After an electric signal greater than the threshold value occurs, the analyzer circuit 32 measures the time period in which the level of the electric signal falls below the threshold value. If the measured time period is less than the specified time period, the analyzer circuit 32 makes a decision that the reply of the visitor is “NO”.

According to the decision, the analyzer circuit 32 continues the interactive download as follows.

(I) In the case of “YES”, the receiving station 30 instructs the transmitting station 20 to send another piece of voice information by using the light that is intensity modulated in response to the electric signal.

(II) In the case of “NO”, the receiving station 30 instructs the transmitting station 20 to halt providing the information.

Instead of the receiving station 30, another control station can carry out the instruction processing.

In this way, the visitor or the terminal user 205 wearing the earphone-type power-sourceless terminal 100 can listen to the voice information by only looking at a desired exhibit 201 or 204 in the exhibition hall

In addition, the transmit/receive station can receive the information from the terminal user 205 whose line of vision is directed toward the transmit/receive station. Therefore installing a plurality of transmit/receive stations 203 and 204 enables the plurality of transmit/receive stations 203 and 204 to make a decision as to which transmit/receive area the user 205 is present. This makes it possible to construct a communication system that can offer more information appropriate for the terminal user.

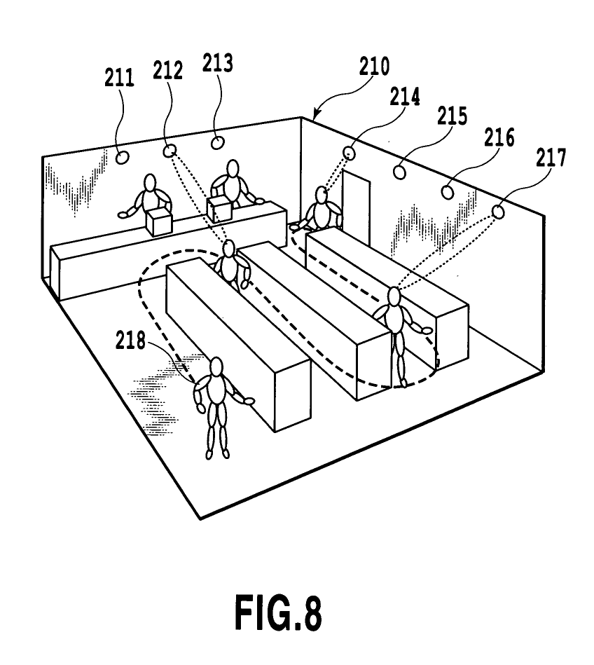

For example, FIG. 8 shows an application of the communication system with such a locating function. In the example of FIG. 8, a plurality of transmit/receive stations 211-217 are disposed in the exhibition hall 210, and the terminal user 218 can be located by the communication between the plurality of transmit/receive stations 211-217 and the terminal user 218. For example, the plurality of transmit/receive stations 211-217 are placed in such a manner that the emitted direction of the optical signals of the transmit/receive stations 211-213 becomes perpendicular to the emitted direction of the optical signals of the transmit/receive stations 214-217, thereby being able to roughly locate the terminal user 218, and to offer information suitable for the terminal user in accordance with the location. Furthermore, utilizing the location history of the terminal user 218 makes it possible to provide the terminal user with further suitable information. To handle a plurality of terminal users, the optical signals used for the individual terminal users can have different wavelengths so that they can be transmitted and received independently.

The foregoing description is made about an application of the communication system in accordance with the present invention. The present invention is further applicable to the following examples.

(1) Providing a signboard with the transmitting station and receiving station enables a reader wearing the power-sourceless terminal to hear the commercial message of the signboard.

(2) Sending out music instead of the voice information from the transmitting station, for example, enables the terminal user to listen to the music with the power-sourceless terminal. The terminal user, on the other hand, can instruct the receiving station to change the music.

(3) Using a plurality of optical signals with specified frequencies as the optical signals makes it possible to assign a plurality of transmit/receive stations to a plurality of terminal user in one-to-one correspondence, thereby being able to transmit different pieces of information to the plurality of terminal users, for example.

Applying the communication system to rehearsal of a chorus makes it possible to transmit the voices of the parts of the chorus separately. In this case, the optical signals to be emitted are provided with the directivity, and the optical signals emitted from the transmitting station and the receiving devices of the power-sourceless terminals are subjected to filters for limiting the pass bands. Thus, the pairs of the plurality of transmit/receive stations and power-sourceless terminals are assigned different pass bands limited by the filters to carry out transmission and reception without crosstalk.

The following examples can be enumerated as variations of the hardware configuration.

(1) As for the mode of outputting the information from the power-sourceless terminal of the terminal user, it is possible to output besides the sound signal the information produced by turning on and off the LED (light-emitting diode), or by varying the intensity of the emitted light. Since an infrared light-emitting diode is used as the light source of the intensity modulated optical signal, the user of the power-sourceless terminal cannot see the light, and hence cannot confirm the reception of the optical signal. To avoid this, the output mode utilizing the visible light is used in conjunction with the infrared light-emitting diode. In this case, to output the visible light, a visible light-emitting diode is used which can be driven by a very small amount of electric power using a part of the electric signal passing through the photoelectric conversion as the electric energy of the driving power supply.

(2) Considering the reception and transmission of the information by the power-sourceless terminal side, the transmitting station side transmits first sections and second sections alternately as illustrated in FIG. 9C. In the first sections, the transmitting station carries out the intensity modulation and transmission of the optical signal for the download communication (thus the first sections are receiving sections from the viewpoint of the terminal side). On the other hand, in the second sections, the transmitting station transmits light with constant intensity, that is, the light without subjected to the intensity modulation, for the upload communication (thus the second sections are transmitting sections from the viewpoint of the terminal side). Accordingly, the user of the power-sourceless terminal can carry out the upload transmission of the information by varying the intensity of the light by turning off and on or the like in the transmission space. Thus, the transmitting station can obtain the information transmitted from the terminal user more positively.

(3) Although the foregoing embodiment employs the intensity modulated optical signal, it can also use a radio wave such as a millimeter wave.

(4) The power-sourceless terminal can perform the intensity modulation of the reflected light without using a power source. For example, an airtight container composed of a transmittable material is placed before the reflecting plate of the power-sourceless terminal. The airtight container includes a film for transferring air vibration as its integral part, and particles for absorbing light such as graphite enclosed in the airtight container. Transferring the voice (air vibration) produced by the user to the film of the airtight container, the intensity of the light passing through the airtight container is modulated in response to the voice level. The receiving station converts the intensity modulated light to the electric signal, and outputs reproduced voice from the speaker or earphone, or carries out the voice recognition, thereby outputting the information transmitted from the terminal user. The intensity modulation by such a means is performed on the light before and/or after the reflection by the reflecting plate.

The more concrete contents thereof will be described in more detail in the following embodiments.

(Second Embodiment)

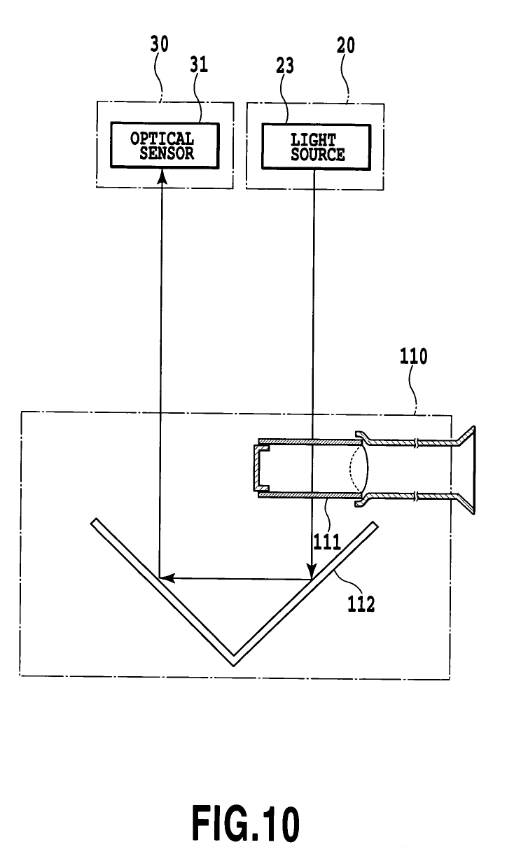

FIG. 10 is a schematic diagram showing a configuration for carrying out the upload transmission of the information from the power-sourceless terminal side by making intensity conversion of the reflected light by the power-sourceless terminal. FIG. 10 shows only a main portion of the power-sourceless terminal for uploading information. The reference numeral 20 designates a transmitting station, 30 designates a receiving station and 110 designates a power-sourceless terminal. The reference numeral 111 designates an optical intensity modulation means capable of varying the transmittance of light without a power supply. To achieve the upload function, the power-sourceless terminal 110 comprises a reflector 112 consisting of a corner cube or the like for reflecting the light from the light source 23 of the transmitting station 20 to approximately the same direction of incidence of the light, and the optical intensity modulation means 111 disposed in the optical path to the optical sensor 31 of the receiving station 30 for passing the light emitted from the light source 23 of the transmitting station 20.

The light emitted from the light source 23 and passing through the optical intensity modulation means 111, that is, the intensity modulated optical signal, is transmitted to the optical sensor 31 of the receiving station 30. As the light source 23 for generating light from the transmitting station 20, a light-emitting diode producing infrared light is used. The optical sensor 31 receives the optical intensity modulated light that is reflected by the reflector 112 in the direction opposite to the direction of incidence. The receiving station 30 discriminates the output of the photoelectric conversion fed from the optical sensor 31, followed by outputting the result. When the transmitting station 20 and receiving station 30 are constructed into one unit, the light source 23 can be incorporated into the receiving station 30, or placed outside the receiving station 30. The placement of the light source 23 is determined in accordance with the application purpose.

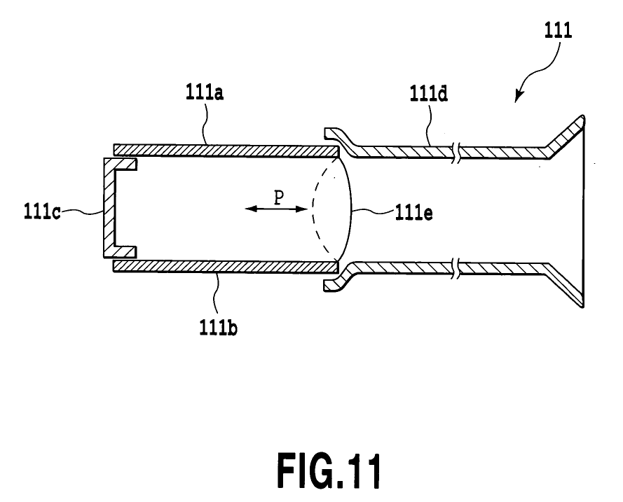

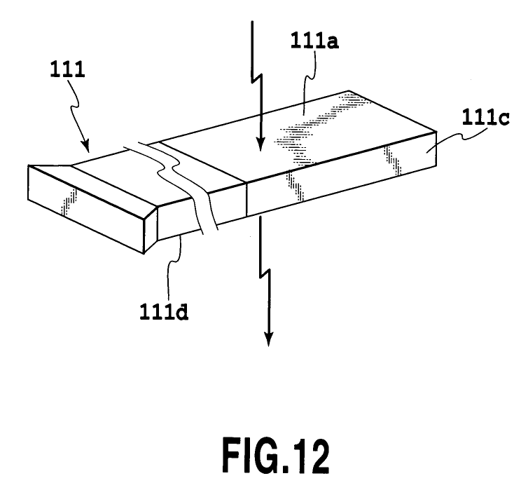

FIG. 11 shows a configuration of the optical intensity modulation means 111. In FIG. 11, reference numerals 111a and 111b designate a transmittable component (such as sheet and film) with a constant transmittance, to which a material that can transmit light is applied. A component 111c forms an airtight container in conjunction with the transmittable components 111a and 111b, and an elastic component 111e. The airtight container modulates the intensity of the light bypassing the light through it. In this case, the intensity of the light passing through the transmittable components 111a and 111b is modulated by varying the thickness of the airtight container that transmits the light. Accordingly, the component 111c through which the light does not pass need not be a transmittable component. To vary the thickness in the optical path direction of the airtight container that transmits the light, the elastic component 111e is provided that expands and contracts in the direction of an arrow P in response to pressure variations. In addition, a tube 111d for leading breath to the elastic component 15, that is, the tube (component) 111d for guiding voice, is provided. Thus, when the terminal user utters at the end of the tube 111d, for example, the elastic component 111e receives the breath, expands and contracts in the direction of the arrow P, thereby varying the thickness in the optical path direction of the airtight container. The airtight container, which is composed of the transmittable components 111a and 111b, component 111c and elastic component 111e, encloses particles for absorbing light such as graphite to vary the optical transmittance in response to the pressure variations. FIG. 12 shows an external appearance of the optical intensity modulation means 111. In FIG. 12, the same or like portions to those of FIG. 11 are designated by the same reference numerals, and their detailed description is omitted here.

To upload, the terminal user of the power-sourceless terminal 110 utters toward the elastic component 111e via the tube 111d while the transmit/receive station (transmitting station 20 and receiving station 30) sends the optical signal to the power-sourceless terminal 110 and the reflector 112 reflects the light. Thus, the air vibration is transmitted to the elastic component 111e, and vibrates the elastic component 111e in the direction of the arrow P. In this way, the dynamic internal pressure in the airtight container varies, and the thickness of the airtight container, through which the light passes, varies in the direction of the optical path. Consequently, the transmittance of the light passing through the airtight container varies, thereby achieving the intensity modulation of the light passing through the transmittable components 111a and 111b.

The receiving station 30 demodulates the light sent back from the power-sourceless terminal 110, and reproduces and outputs the voice transmitted from terminal user.

As described above, the present embodiment carries out the optical intensity modulation using the dynamic pressure variations. Consequently, it does not require any electrical power supply, thereby being able to transmit the information from the terminal user without using a power supply.

The foregoing embodiment can be modified in the following fashions.

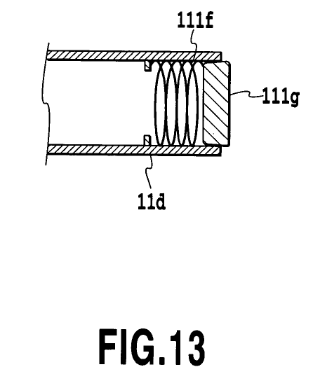

(1) As a means for generating the variations in the air pressure other than the voice, a structure as shown in FIG. 13 can be used. In FIG. 13, the reference numeral 111d designates a tube, 111f designates a spring and 111g designate a button. The button 111g is pressed by the spring 111f. The terminal user transmits information by mechanical operation of depressing the button 111g to transmit air vibrations to the elastic component 111e (not shown in FIG. 13). It is also possible to transmit the pressure variations caused by the operation of the button 111g to the elastic component 15 (not shown in FIG. 13) by filling the tube 111d with a fluid.

(2) As another mechanism of transmitting the air vibration, a structure utilizing temperature variations can also be used. For example, a shape-memory alloy can be used to generate the air vibrations in such a manner that an information transmitting person touches or releases the shape-memory alloy component to vary the shape thereof.

(3) Although the foregoing embodiments are described by way of example of using light, a radio wave other than the light can be used. In this case, the airtight container suitable for the radio wave is employed.

(4) Although the foregoing embodiments include the component for guiding the voice, it can be removed to downsize the apparatus. In this case, the communication performance is degraded.

(5) As the optical system for reflecting the received light, it is possible to use an optical system other than that as shown in FIG. 10. For example, a combination of a lens and reflecting plate is also applicable depending on the application purpose or geometry.

(6) The communication performance is further improved by providing the optical intensity modulation means 111 with an optical system for guiding or shielding the light from the light source 23.

(7) It is necessary for the airtight container for uploading to include at least a transmittable component for transmitting a radio wave, and an elastic component for transmitting vibration.

(8) The optical intensity modulation means 111 can be disposed such that it transmits both the input and output light, or transmits only the output light.

As described above, the present embodiment 2 modulates the intensity of the incident light by the pressure variations using air vibrations, and reflects the modulated light in the direction opposite to the direction of incidence. Accordingly, it can obviate the need for the electrical light source, thereby being able to transmit the information without the power supply. In addition, when the optical modulation is carried out by producing air vibration by voice, the receiving station 30 can reproduce the voice by converting the optical signal into the electric signal. Furthermore, the information can be transmitted in response to the operation of the user by installing a means for generating the air vibration.

(Third Embodiment)

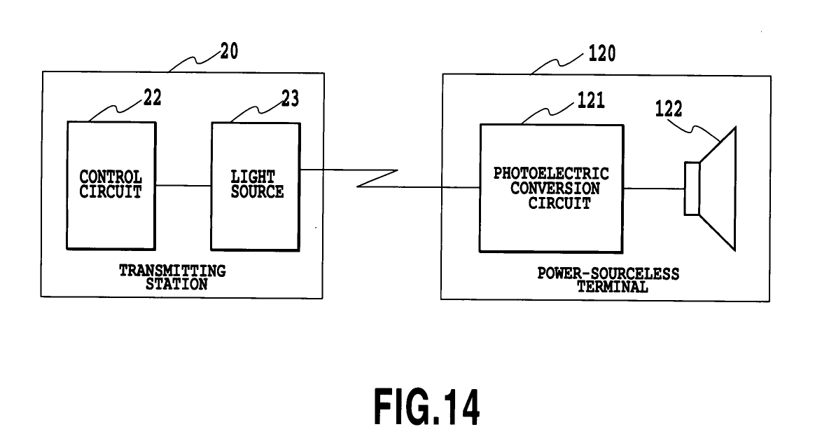

FIG. 14 is a block diagram showing a communication system in accordance with the present invention. In FIG. 14, the communication system comprises a power-sourceless terminal 120 and the transmitting station 20 to operate the system as a power-sourceless download apparatus. The power-sourceless terminal 120 and transmitting station 20 correspond to the foregoing power-sourceless terminal 10 and transmitting station 20 (FIGS. 1-3). The power-sourceless terminal 120 of the present embodiment 3 serves only as a power-sourceless download apparatus. Thus, although it does not include the reflecting means for uploading, a configuration that has the reflecting means is also possible. The power-sourceless terminal 120 comprises a power-sourceless photoelectric conversion circuit (photoelectric conversion device or optical sensor) 121 for receiving the light and converting it to an electric signal; and a power-sourceless voice output means 143 such as an earphone or speaker for (reproducing and) outputting the electric signal passing through the photoelectric conversion by the photoelectric conversion circuit 121 as the voice. As the photoelectric conversion circuit 121, a circuit is used that generates the electric signal with the level (for example, voltage) corresponding to the intensity of the light received.

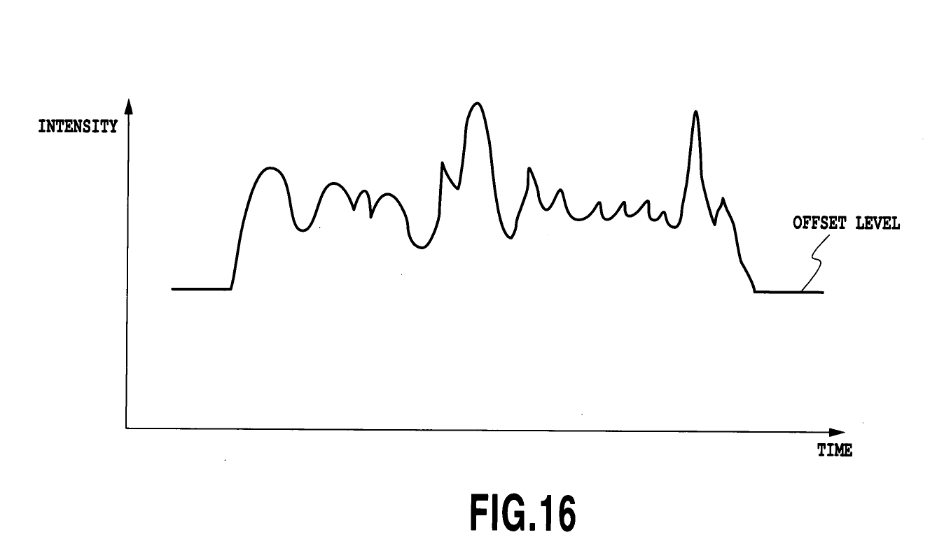

The transmitting station 20 includes the light source 23 and the control circuit 22 for controlling the intensity of the light emitted from the light source 23. As the light source 23, a variety of light sources such as an LED are available in accordance with the application purposes. As the control circuit 22, a processor such as a CPU, or an IC circuit is applicable. The light-emitting intensity can be controlled by controlling the power voltage supplied to the light source 23. In the present embodiment, an offset level is determined in correspondence to the waveform of the voice signal obtained from the voice to determine a specified intensity characteristic as illustrated in FIG. 16. According to the intensity characteristic, the control circuit 22 controls the light-emitting intensity of the light source 23. The intensity characteristic as illustrated in FIG. 16 has a fixed offset level that is determined appropriately in accordance with the receiving performance of the power-sourceless terminal 120.

With such a configuration, the light with the intensity characteristic as illustrated in FIG. 16 is emitted from the light source 23 of the transmitting station 20 under the control of the control circuit 22. As for the emitted light, the photoelectric conversion circuit 121 of the power-sourceless terminal 120 receives it, and converts it to an electric signal. Since the resultant electric signal has the same frequency characteristic as the intensity characteristic illustrated in FIG. 16, the speaker or the voice output means 143 reproduces and outputs the voice.

Although the foregoing embodiment transmits information using the light with the intensity distribution corresponding to the variations themselves of the level of the waveform of the electric signal, this is not essential. For example, though the information is transmitted by a light having intensity distribution corresponding to variations itself of the signal level of the signal waveform of the electric signal in the preferred embodiments, it is also possible to transmit the information by generating an optical signal with the intensity distribution corresponding to variations of the waveform of the envelope of the waveform of an electric signal as the electric signal AM modulated by the carrier wave.

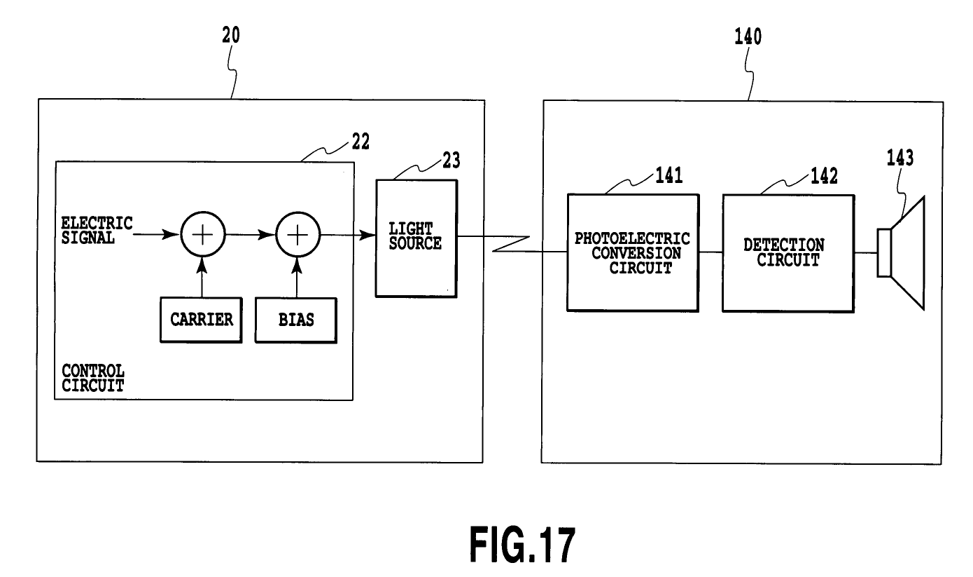

FIG. 17 shows such a system configuration. In FIG. 17, the control circuit 22 in the transmitting station 20, which receives the electric signal to be transmitted, has an adder for superposing the electric signal on the carrier, and has another adder for adding a bias, thereby generating the electric signal passing through the AM modulation. Since the AM modulation circuit itself is well-known, the description thereof is omitted. The light corresponding to the variations of the generated electric signal is produced by the light source 23 to be sent. In other words, the light source 23 generates the light under the control of the control circuit 22, which is carried out in response to the AM modulated electric signal. The light has the intensity distribution corresponding to the variations of the waveform of the envelope of the waveform of the AM modulated electric signal.

In this case, the electric signal, which undergoes the photoelectric conversion by a photoelectric conversion circuit 141 in a power-sourceless terminal 140, is detected by a detection circuit 142 for detecting it without using a power supply such as a diode. Thus, the electric signal to be transmitted is extracted, and is output from the power-sourceless voice output means 143 such as an earphone or speaker.

In this way, a plurality of voicees can be transmitted at the same time. In addition, the download side can select the voice of a desired frequency in the same manner as the AM radio to listen to the voice.

As to the foregoing embodiments, a variety of applications and modifications can be conceived, some of which will be described below.

(1) The download apparatus of the communication system can provide the terminal user with information by preparing voice in advance. For example, the transmitting station is put on a giraffe in a zoo, and a visitor to the giraffe borrows the power-sourceless terminal. The visitor, or the terminal user, receives with the power-sourceless terminal the optical signal to be sent by the transmitting station on the giraffe. Thus, the voice output means reproduces and outputs the voice about the giraffe. Instead of the information, a cry of the animal can be transmitted. The transmitting station can also placed on an exhibit in a museum, or in a water tank of an aquarium to provide information to a visitor.

(2) As for the information transmitted by the intensity modulation of the light, not only the voice and cries of animals, but also acoustic information such as music can be transmitted. The transmission is carried out by emitting light with the same intensity distribution characteristic as that of the signal waveform of the acoustic signal to be transmitted.

(3) Although the foregoing embodiments determine the signal waveforms to be transmitted in advance, this is not essential. For example, the voice, cries of animals or acoustic sounds are picked up by a microphone, and converted to an electric signal, which causes the light source of the transmitting station to emit light in response to the intensity distribution characteristic corresponding to the waveform of the electric signal, thereby enabling real-time information transmission. Thus, when preparing the waveforms in advance of the electric signals to be transmitted, the waveform data can be stored in a memory means such as an IC memory and hard disk. In contrast, to transfer the waveforms in real time, the system can be configured by adding the electric signal generating means such as a microphone or an input means for inputting the electric signal from other apparatus.

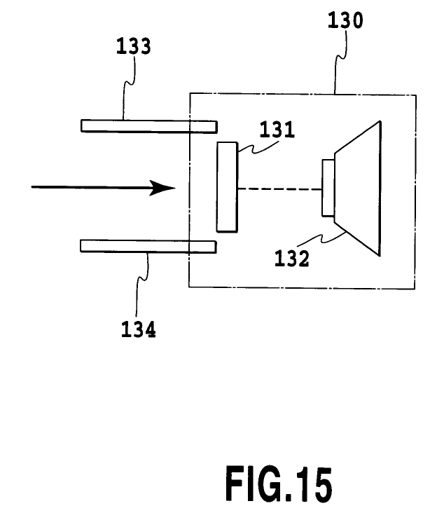

(4) To receive light only from the transmitting station, the example as shown in FIG. 15 can be employed which includes a means for guiding only the light traveling in a specified direction to a photoelectric conversion circuit 131 in a power-sourceless terminal 130. In FIG. 15, in which only a main portion is represented by solid lines, the reference numeral 131 designates the photoelectric conversion circuit, and reference numerals 133 and 134 each designate a shielding plate. As a means for guiding the light only in the specified direction up to the photoelectric conversion circuit 131, a well-known means such as an optical system like a lens is applicable besides the shielding plates. In addition, the means for guiding only the light in the specified direction can be provided to the light source 23 on the information transmission side.

(5) Although the foregoing embodiments employ the voice reproduction means such as the power-sourceless earphone or speaker, a speaker requiring a power supply can also be used. In this case, a storage battery is prepared so that it stores the output (electric energy) of the photoelectric conversion circuit. The storage battery (storage means) is used as a power supply for driving the speaker, thereby enabling the speaker to reproduce a large voice output.

(6) Although the foregoing embodiments each employ the single transmitting station and the single power-sourceless terminal, this is not essential. For example, a total system can have such a configuration as including a plurality of transmitting stations and a single power-sourceless terminal, a single transmitting station and a plurality of power-sourceless terminals, or a plurality of transmitting stations and a plurality of power-sourceless terminals in accordance with application purposes.

(7) As radio waves, it is possible to use visible light, or invisible radio waves such as infrared rays, millimeter waves, microwaves and X rays. In addition, according to the application purpose, a radio wave with or without directivity can be selected. Using the visible light can notify the terminal user carrying the power-sourceless terminal for the download of the presence of the transmitting station. In contrast, to keep the presence of the transmitting station 20 secret to the terminal user of the power-sourceless terminal, the invisible radio wave is applicable.

(8) Emitting radio waves (optical signals) with different wavelengths enables multichannel information communication. In this case, the information transmitter includes a plurality of radio wave output units, and passes the radio waves through bandpass filters each transmitting only a desired wavelength. In addition, the receiving side (power-sourceless terminal) includes a plurality of “conversion means for generating electric signals with levels corresponding to the intensities of the radiowaves”, each of which is supplied with only the wavelength passing through a matching bandpass filter.

(9) The output level of the output means (earphone or speaker) can be made variable. In this case, the output signal level of the photoelectric conversion circuit 121 is adjusted by manual operation of a volume or the like.

(10) As the output means for perceptibly output the electric signal produced by the photoelectric conversion of the photoelectric conversion circuit, a vibration device for outputting the electric signal in vibration, or a means for stimulating the sense of taste or smell is available besides the foregoing voice output means, and it can be selected in accordance with the application purposes.

(11) Although the foregoing embodiments generate the intensity modulated light in response to the AM modulated electric signal, this is not essential. For example, an electric signal passing through analog modulation based on a variety of modulation schemes such as FM modulation is also available instead of the AM modulation to generate the intensity modulated light. Digital modulation is also applicable.

As described above, the communication system in accordance with the present invention can provide the communication method suitable for the environment in which the wired communication is difficult. This is because it transmits the electric signal by the modulation intensity of the light rather than through the wired channel. In addition, the download can be carried out by the simple, compact, lightweight power-sourceless terminal without the power supply.

More specifically, as for the user terminal required for the optical space communication with the environment side having the transmitting station and receiving station disposed, it includes the photoelectric conversion means such as a solar cell, and the voice output means such as an earphone, as well as the reflecting means such as the retroreflector as needed, and is capable of the power-sourceless drive, thereby being able to implement the simple, compact, lightweight power-sourceless terminal. Employing the power-sourceless terminal enables the environment side to take a very simple configuration, to readily download the information to the terminal user, and to easily upload the information from the terminal user, thereby being able to implement the very convenient optical space communication system.

For example, voice information on an exhibition hall or exhibits is transmitted so that participants can receive and hear the information through the power-sourceless terminals. Thus, a variety of one-to-many communication spaces can be implemented as to events or exhibitions using the power-sourceless terminals for providing various types of information.

In addition, the configuration, in which the terminal user can vary the intensity of the light received by the power-sourceless terminal with his or her hand or by operating the power-sourceless optical intensity modulation means installed in the terminal, enables the terminal user to upload information to the environment side using only the terminal the user carries, and thus enables the individual participants to send their own intentions in the events or exhibitions, thereby being able to implement the many-to-one communication space together with the one-to-many communication. As for the optical intensity modulation means, since it carries out the intensity modulation of light in response to the pressure variations utilizing the vibrations of air or the like, it enables the power-sourceless drive.

Furthermore, the communication system can reduce the effect of noise on the light used for the communication by passing the electric signal of the information, which is to be downloaded from the environment side to the terminal side, through the analog modulation such as AM or FM modulation, or the digital modulation such as PAM, PWM or PPM, thereby being able to implement the superior communication space.

In this case, although the power-sourceless terminal must include a demodulation means such as a demodulation circuit, its power-sourceless drive is also possible depending on the circuit configuration and devices used. Alternatively, even if the power supply is required, it becomes possible without using any other signal lines for the power supply or constant voltage circuit by storing the electric energy of the electric signal obtained by converting the received light by the photoelectric conversion means in the storage means such as a secondary battery. The power-sourceless terminal is sufficiently compact and lightweight even when the demodulation circuit or secondary battery is installed, thereby being able to keep the portability and fittability.

As a matter of course, the power-sourceless terminal can transmit and receive information without a power supply regardless of the weather conditions. In addition, since the power-sourceless terminal has a simple circuit configuration, it is inexpensive and hence disposable. According to the application purposes, the power-sourceless terminal can output the information in the form of light or voice. Therefore the present invention is applicable to a variety of application purposes such as providing information.

1. A communication system with a power-sourceless terminal comprising:
a power-sourceless terminal including photoelectric conversion means for receiving an intensity modulated optical signal and converting it to an electric signal, and voice output means for outputting the electric signal converted by said photoelectric conversion means in the form of voice; and
a transmitting station including transmission means for sending an optical signal having its intensity modulated depending on an electric signal of information to be transmitted to said power-sourceless terminal.

2. A communication system with a power-sourceless terminal comprising:
a power-sourceless terminal including photoelectric conversion means for receiving an intensity modulated optical signal and converting it to an electric signal, demodulation means for demodulating the electric signal converted by said photoelectric conversion means, and voice output means for outputting the electric signal demodulated by said demodulation means in the form of voice; and
a transmitting station including modulation means for carrying out analog modulation, or digital modulation of an electric signal of information to be transmitted, and transmission means for sending an optical signal having its intensity modulated depending on the electric signal modulated by said modulation means to said power-sourceless terminal.

3. A communication system with a power-sourceless terminal comprising:
a power-sourceless terminal including photoelectric conversion means for receiving a portion of an intensity modulated optical signal and converting it to an electric signal, voice output means for outputting the electric signal converted by said photoelectric conversion means in the form of voice, and reflecting means for receiving and reflecting another portion of the intensity modulated optical signal, said power-sourceless terminal enabling a terminal user to modify the intensity of the optical signal in accordance with information to be sent by the terminal user upon reflection by said reflecting means;
a transmitting station including transmission means for sending the optical signal having its intensity modulated depending on an electric signal of information to be transmitted to said power-sourceless terminal; and
a receiving station including light receiving means for receiving the optical signal reflected by said reflecting means of said power-sourceless terminal, and information analyzing means for analyzing the information the terminal user sends from said power-sourceless terminal in accordance with the intensity of the optical signal received by said light receiving means.

4. A communication system with a power-sourceless terminal comprising:
a power-sourceless terminal including photoelectric conversion means for receiving an intensity modulated optical signal and converting it to an electric signal, voice output means for outputting the electric signal converted by said photoelectric conversion means in the form of voice, and reflecting means for receiving and reflecting upload light, said power-sourceless terminal enabling a terminal user to modify the intensity of the upload light in accordance with information to be sent by the terminal user upon reflection by said reflecting means;
a transmitting station including transmission means for sending the optical signal having its intensity modulated depending on an electric signal of information to be transmitted to said power-sourceless terminal; and
a receiving station including light-emitting means for emitting the upload light, light receiving means for receiving the upload light reflected back by said reflecting means of said power-sourceless terminal, and information analyzing means for analyzing the information the terminal user sends from said power-sourceless terminal in accordance with the intensity of the upload light received by said light receiving means.

5. A communication system with a power-sourceless terminal comprising:
a power-sourceless terminal including photoelectric conversion means for receiving a portion of an intensity modulated optical signal and converting it to an electric signal, demodulation means for demodulating the electric signal converted by said photoelectric conversion means, voice output means for outputting the electric signal demodulated by said demodulation means in the form of voice, and reflecting means for receiving and reflecting another portion of the intensity modulated optical signal, said power-sourceless terminal enabling a terminal user to modify the intensity of the optical signal in accordance with information to be sent by the terminal user upon reflection by said reflecting means;
a transmitting station including modulation means for carrying out analog modulation or digital modulation of an electric signal of information to be transmitted, and transmission means for sending an optical signal having its intensity modulated depending on the electric signal modulated by said modulation means to said power-sourceless terminal; and
a receiving station including light receiving means for receiving the optical signal reflected by said reflecting means of said power-sourceless terminal, and information analyzing means for analyzing the information the terminal user sends from said power-sourceless terminal in accordance with the intensity of the optical signal received by said light receiving means.

6. A communication system with a power-sourceless terminal comprising:
a power-sourceless terminal including photoelectric conversion means for receiving an intensity modulated optical signal and converting it to an electric signal, demodulation means for demodulating the electric signal converted by said photoelectric conversion means, voice output means for outputting the electric signal demodulated by said demodulation means in the form of voice, and reflecting means for receiving and reflecting upload light, said power-sourceless terminal enabling a terminal user to modify the intensity of the upload light reflected by said reflecting means in accordance with information to be sent by the terminal user;
a transmitting station including modulation means for carrying out analog modulation or digital modulation of an electric signal of information to be transmitted, and transmission means for sending an optical signal having its intensity modulated depending on the electric signal modulated by said modulation means to said power-sourceless terminal; and
a receiving station including light-emitting means for emitting the upload light, light receiving means for receiving the upload light reflected back by said reflecting means of said power-sourceless terminal, and information analyzing means for analyzing the information the terminal user sends from said power-sourceless terminal in accordance with the intensity of the upload light received by said light receiving means.

7. The communication system as claimed in claim 1, wherein said photoelectric conversion means of said power-sourceless terminal includes a solar cell.

8. The communication system as claimed in claim 1, wherein said voice output means of said power-sourceless terminal includes at least one of an earphone, a headphone and a speaker.

9. The communication system as claimed in claim 3, wherein said reflecting means of said power-sourceless terminal includes a retroreflector.

10. The power-sourceless terminal used in the communication system as claimed in claim 1, wherein a solar cell used as said photoelectric conversion means, and at least one of an earphone, a headphone and a speaker used as said voice output means are arranged so as to form integrated structure.

11. The power-sourceless terminal as claimed in claim 10, wherein the solar cell and at least one of the earphone, the headphone and the speaker are arranged so as to form integrated structure such that when the terminal user wears at least one of the earphone, the headphone and the speaker, a light receiving surface of said solar cell faces in a direction of the terminal user's eyes.

12. The power-sourceless terminal used in the communication system as claimed in claim 3, wherein a solar cell used as said photoelectric conversion means, at least one of an earphone, a headphone and a speaker used as said voice output means and a retroreflector used as said reflecting means are arranged so as to form integurated structure.

13. The power-sourceless terminal as claimed in claim 12, wherein the solar cell, at least one of the earphone, the headphone and the speaker, and the retroreflector are arranged so as to form integurated structure such that when the terminal user wears at least one of the earphone, the headphone and the speaker, a light receiving surface of said solar cell and a light reflecting surface of the retroreflector face in a direction of the terminal user's eyes.

14. The power-sourceless terminal used in the communication system as claimed in claim 3, said power-sourceless terminal further comprising:
optical intensity modulation means for varying intensity of the optical signal passing through a airtight container thereof due to variations of optical transmittance of said airtight container in accordance with pressure fluctuations, said airtight container having a light transmittable elastic component capable of letting the optical signal to enter into and exit from said airtight container and a plurality of particles sealed therein; and
wherein said power-sourceless terminal is capable of varying intensity of the optical signal in accordance with the information by said optical intensity modulation means.

15. The power-sourceless terminal used in the communication system as claimed in claim 4, said power-sourceless terminal further comprising:
optical intensity modulation means for varying intensity of the upload light passing through an airtight container thereof due to variations of optical transmittance of said airtight container in accordance with pressure fluctuations, said airtight container having elastic component capable of letting the upload light to enter into and exit from said airtight container and a plurality of particles sealed therein; and
wherein said power-sourceless terminal is capable of varying intensity of the upload light in accordance with the information by said optical intensity modulation means.

16. The power-sourceless terminal as claimed in claim 14, wherein said optical intensity modulation means further comprises a component operable to provide said airtight container with the pressure fluctuation by conducting voice to said airtight container, said voice expressing the information to be sent by the terminal user.

17. The power-sourceless terminal as claimed in claim 14, wherein said optical intensity modulation means further comprises a component operable to provide said airtight container with the pressure fluctuations in accordance with mechanical operations by the terminal user, said mechanical operation expressing the information to be sent by the terminal user.

18. The communication system as claimed in claim 1, wherein said power-sourceless terminal further comprises storage means for storing electric energy of the electric signal converted by said photoelectric conversion means.

19. The power-sourceless terminal as claimed in claim 10, wherein said power-sourceless terminal further comprises storage means for storing electric energy of the electric signal converted by said photoelectric conversion means.

20. The communication system as claimed in claim 1, wherein said transmitting station further comprises a component operable to transmit the optical signal sent out from said transmission means in a specified direction, and wherein said power-sourceless terminal further comprises optical guiding path for leading the optical signal from the specified direction to said photoelectric conversion means.
